(19) United States
(12) Patent Application Publication
(10) Pub. No.: US 2019/0177128 A1
(43) Pub. Date: Jun. 13, 2019

(54) LOWER GUIDING SYSTEM OF AN ELEVATOR PANEL AND ELEVATOR SYSTEM

(71) Applicant: Otis Elevator Company, Farmington, CT (US)

(72) Inventor: Weiliang Ruan, Hangzhou (CN)

(21) Appl. No.: 16/216,078

(22) Filed: Dec. 11, 2018

(30) Foreign Application Priority Data
Dec. 11, 2017 (CN) 201721710472.1

(51) Int. Cl. B66B 13/30; B66B 13/08

(52) U.S. Cl. CPC B66B 13/303; B66B 13/08; B66B 13/301

(57) ABSTRACT

A lower guide assembly for an elevator landing door system, including: a landing door plate; an anti-off component; and a sill component that includes: a base; and a first support and a second support that are detachably mounted on the base. The first support, the second support and the base form a guide slot that extends along a translating direction of the landing door plate, the width of a space of the guide slot that is used to accommodate the body of the anti-off component is less than the width of the head of the anti-off component, the base is provided with a first protrusion that extends toward the first support at an outer side near the first support, and the first support is provided with a recess used to accommodate the first protrusion.

### FOREIGN PRIORITY

This application claims priority to Chinese Patent Application No. 201721710472.1, filed Dec. 11, 2017, and all the benefits accruing therefrom under 35 U.S.C. § 119, the contents of which in its entirety are herein incorporated by reference.

### TECHNICAL FIELD

The utility model relates to the field of elevator technologies, and specifically, the utility model relates to a lower guide assembly for an elevator landing door system and an elevator system provided with the lower guide assembly for an elevator landing door system.

### BACKGROUND ART

Elevators are an indispensable part of modern architecture and become the optimal choice for people to travel through buildings because of its convenience and quickness. However, an increasingly growing number of elevators are put into use, and more attention has been paid to their safety. Especially when elevator landing doors are hit by abnormal external force to lead to fall-off of door leaves, accidents of falling from elevators draw the most public attention.

At present, in an anti-off apparatus of an elevator landing door, hooks embedded at the inner side, outer side, or both sides of a landing door sill are mounted at the bottom of a landing door plate, or lock hooks and lock brackets are arranged on the middle side of the landing door plate, or a long bent member is mounted perpendicularly at a side surface of the landing door to protect the landing door plate. However, these technologies greatly modify the existing sills, and even require specialized matching sills. This dramatically increases the cost of the whole elevator system if the number of landing door plates is large.

Therefore, a lower guide assembly for an elevator landing door system is in urgent need to effectively solve the above problem.

### SUMMARY OF THE UTILITY MODEL

In view of the above, according to a first aspect of the utility model, a lower guide assembly for an elevator landing door system is provided to effectively solve the above problem in the prior art and problems in other aspects. In the lower guide assembly for an elevator landing door system according to the utility model, the lower guide assembly for an elevator landing door system includes: a landing door plate; an anti-off component detachably fixed under the landing door plate and including a body having a smaller width and a head having a greater width; a sill component including: a base; and a first support and a second support that are detachably mounted on the base, wherein the first support, the second support and the base form a guide slot that extends along a translating direction of the landing door plate and is used to at least partially accommodate the anti-off component, and the width of a space of the guide slot that is used to accommodate the body of the anti-off component is less than the width of the head of the anti-off component to prevent the anti-off component from falling off from the guide slot, and the base is provided with a first protrusion that extends toward the first support at an outer side near the first support, and the first support is provided with a recess used to accommodate the first protrusion.

In another beneficial implementation manner of the lower guide assembly for an elevator landing door system according to the utility model, the base is provided with a second protrusion that extends toward the second support at an outer side near the second support, and the second support is provided with a recess used to receive the second protrusion.

In still another beneficial implementation manner of the lower guide assembly for an elevator landing door system according to the utility model, the base includes a bottom wall, and a first sidewall and a second sidewall that are located at two sides of the bottom wall, wherein the first protrusion extends toward the first support from an end portion of the first sidewall, and the second protrusion extends toward the second support from an end portion of the second sidewall.

In yet another beneficial implementation manner of the lower guide assembly for an elevator landing door system according to the utility model, the first protrusion and the second protrusion extend along a direction parallel to the bottom wall of the base.

In further another beneficial implementation manner of the lower guide assembly for an elevator landing door system according to the utility model, the first support and/or the second support are/is fixed on the base by a fastener.

In yet another beneficial implementation manner of the lower guide assembly for an elevator landing door system according to the utility model, the guide slot has an L-shaped or an inverted T-shaped cross section.

In still another beneficial implementation manner of the lower guide assembly for an elevator landing door system according to the utility model, the first support and the second support are in the same shape and are arranged on two sides of the base symmetrically.

In further another beneficial implementation manner of the lower guide assembly for an elevator landing door system according to the utility model, the bottom of the landing door plate is provided with multiple anti-off components that are spaced from each other.

In yet another beneficial implementation manner of the lower guide assembly for an elevator landing door system according to the utility model, the anti-off component is fixed under the landing door plate by a fastener.

In further another beneficial implementation manner of the lower guide assembly for an elevator landing door system according to the utility model, the anti-off component is a metal component having an L-shaped or an inverted T-shaped cross section.

In still another beneficial implementation manner of the lower guide assembly for an elevator landing door system according to the utility model, the first sidewall and the second sidewall are perpendicular to the bottom wall and are parallel to each other.

In yet another beneficial implementation manner of the lower guide assembly for an elevator landing door system according to the utility model, the guide slot is provided with a boss that extends toward the body of the anti-off component.

In further another beneficial implementation manner of the lower guide assembly for an elevator landing door system according to the utility model, at least one of the multiple anti-off components is arranged at an end portion near the landing door plate.

In still another beneficial implementation manner of the lower guide assembly for an elevator landing door system according to the utility model, the first support and the second support are made of aluminum alloy.

In further another beneficial implementation manner of the lower guide assembly for an elevator landing door system according to the utility model, the base and/or the anti-off component are/is made of steel.

In yet another beneficial implementation manner of the lower guide assembly for an elevator landing door system according to the utility model, the anti-off component is a bolt.

In still another beneficial implementation manner of the lower guide assembly for an elevator landing door system according to the utility model, the lower guide assembly for an elevator landing door system further includes a sliding block used to guide the landing door plate to move, and the guide slot is provided with a guide surface used to enable the sliding block to slide.

In further another beneficial implementation manner of the lower guide assembly for an elevator landing door system according to the utility model, the sliding block is fitted on the body of the anti-off component or is arranged at the bottom of the landing door plate and spaced from the anti-off component.

In yet another beneficial implementation manner of the lower guide assembly for an elevator landing door system according to the utility model, the sliding block is made of an abrasion-proof material.

In addition, according to a second aspect of the utility model, an elevator system is further provided, and the elevator system is provided with the lower guide assembly for an elevator landing door system.

As can be known, the lower guide assembly for an elevator landing door system according to the utility model not only can prevent an elevator landing door from falling off from a sill component due to any one or more hits, but also can effectively prevent a person from falling into a hoistway as he/she hits or leans against a landing door. The implementation of the lower guide assembly for an elevator landing door system according to the utility model neither needs to greatly modify the structure of the existing elevator system nor needs to add a special material, and therefore, the whole apparatus is simple, practical, and low in cost.

### BRIEF DESCRIPTION OF THE DRAWINGS

The technical solution of the utility model is described in further detail below with reference to accompanying drawings and specific implementation manners, wherein:

FIG. 1 is a schematic structural diagram of a first specific implementation manner of a lower guide assembly for an elevator landing door system according to the utility model; and

FIG. 2 is a schematic structural diagram of a second specific implementation manner of a lower guide assembly for an elevator landing door system according to the utility model.

### DETAILED DESCRIPTION

The specific implementation manners of the utility model are described in detail below with reference to the accompanying drawings. First, it should be noted that orientation terms such as up, down, left, right, front, rear, inside, outside, top, and bottom that are mentioned or may be mentioned in the specification are defined with respect to constructions shown in the accompanying drawings. They are relative concepts, and therefore, they may correspondingly change according to different positions and different use states thereof. As a result, these or other orientation terms should not be construed as limitative terms.

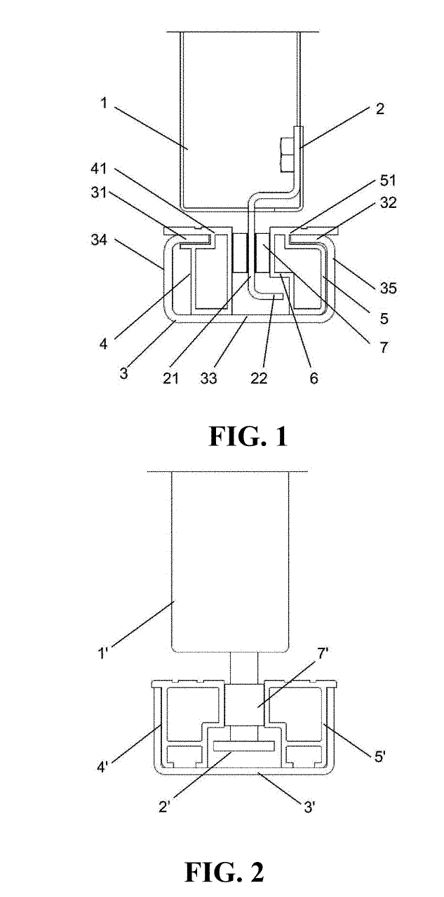

FIG. 1 shows a specific implementation manner of a lower guide assembly for an elevator landing door system according to the utility model. The lower guide assembly for an elevator landing door system can be arranged on each floor in a building. Generally, when an elevator car does not arrive at a floor where the lower guide assembly for an elevator landing door system is located, an elevator landing door is kept closed constantly. The landing door can open together with an elevator car door when the elevator car arrives to allow a passenger to enter or leave the elevator. As can be clearly seen from FIG. 1, the lower guide assembly for an elevator landing door system includes a landing door plate 1, an anti-off component 2, a sill component, and other components. The anti-off component 2 can be made of a material such as steel, and is fixed under the landing door plate 1 detachably by, for example, using a fastener such as a bolt. The anti-off component 2 includes a body 21 having a smaller width and a head 22 having a greater width. That is, the width of the body 21 of the anti-off component 2 is less than the width of the head 22. The sill component includes: a base 3 that can be made of a metal such as steel; and a first support 4 and a second support 5 that are mounted on the base 3 detachably by, for example, using a fastener such as a bolt, and are located on different sides of the anti-off component 2, respectively. The first support 4, the second support 5 and the base 3 form a guide slot that extends along a translating direction of the landing door plate 1, so as to at least partially accommodate the anti-off component 2. Preferably, the first support 4 and the second support 5 are made of a material such as aluminum alloy.

In order to prevent the anti-off component 2 from falling off from the guide slot during sliding of the landing door plate 1 to cause a failed anti-off function of the anti-off component 2, in the utility model, the width of a space of the guide slot that is used to accommodate the body 21 of the anti-off component 2 is designed to be less than the width of the head 22 of the anti-off component 2. In other words, the width of the head 22 of the anti-off component 2 is designed to be greater than the width of the space of the guide slot that is used to accommodate the body 21 of the anti-off component 2. It should be noted that the “width” here mainly refers to the width of a cross section of the guide slot, that is, the width seen from the view orientation of FIG. 1.

In the embodiment shown in FIG. 1, the base 3 is provided with a first protrusion 31 that extends toward the first support 4 at an outer side near the first support 4, and the first support 4 is provided with a recess 41 used to accommodate the first protrusion 31. Further, the base 3 is further provided with a second protrusion 32 that extends toward the second support 5 at an outer side near the second support 5, and the second support 5 is provided with a recess 51 used to receive the second protrusion 32, as shown in FIG. 1. In an off-site field, after the landing door plate 1 of the elevator is opened, an operator in the car generally pushes a weight into or out of the elevator car by using a barrow, and in this case, rollers of the barrow always apply large forces to the first support 4 or the second support 5 when passing through the sill component, such that the first support 4 or the second support 5 is bent outward and deformed. The first protrusion 31 located at the outer side of the base 3 near the first support 4 and the second protrusion 32 located at the outer side of the base near the second support 5 well support the first support 4 and the second support 5, such that the whole sill component has a firmer structure.

With reference to the above embodiment, in another preferred embodiment, the base 3 can further include a bottom wall 33, and a first sidewall 34 and a second sidewall 35 that are located on two sides of the bottom wall 33. Moreover, the first protrusion 31 extends toward the first support 4 from an end portion of the first sidewall 34, preferably along a direction parallel to the bottom wall 33 of the base 3. The second protrusion 32 extends toward the second support 5 from an end portion of the second sidewall 35, preferably along the direction parallel to the bottom wall 33 of the base 3. In this embodiment, the first sidewall 34 and the second sidewall 35 are optionally designed to be perpendicular to the bottom wall 33 and parallel to each other.

Still referring to FIG. 1, the anti-off component 2 can be designed as a metal component to facilitate manufacturing, and the metal component has an L-shaped cross section. Correspondingly, the guide slot has an L-shaped cross section. As can be clearly seen from the figure, the guide slot is provided with a boss 6 that extends toward the body of the anti-off component 2.

FIG. 2 shows another specific implementation manner of a lower guide assembly for an elevator landing door system according to the utility model. The first support 4′ and the second support 5′ are in the same shape and size, and are arranged on two sides of the base 3′ of the sill component symmetrically. As an example, the guide slot has an inverted T-shaped cross section. Correspondingly, in order to prevent the anti-off component 2′ from falling off from the guide slot, the anti-off component 2′ can be configured into a metal component having an inverted T-shape cross section. Structures of components such as the first/second protrusion and the matching recess on the first/second support in the sill component can be obtained with reference to the first specific embodiment, and will not be repeated here.

Those skilled in the art can understand that in a building, the quantity and open direction of landing doors of each floor can be set according to actual requirements. For example, a double-door elevator door has landing door plates that open towards two directions, and a single-door elevator door generally has a landing door plate that opens toward one direction. Therefore, when the landing door plate is wide, the bottom of the landing door plate can be provided with multiple anti-off components that are arranged at intervals. Further, at least one of the multiple anti-off components is arranged at an end portion near the landing door plate.

Referring to FIG. 1 or FIG. 2 again, the lower guide assembly for an elevator landing door system further includes a sliding block 7, 7′ used to guide the landing door plate 1 to move. The guide slot is provided with a guide surface used to enable the sliding block 7, 7′ to slide. The sliding block 7, 7′ is fitted on the body 21 of the anti-off component 2, 2′, or is arranged at the bottom of the landing door plate 1 and spaced from the anti-off component 2. Optionally, the sliding block 7, 7′ is made of an abrasion-proof material.

In addition, the utility model further provides an elevator system, and the elevator system includes the lower guide assembly for an elevator landing door system.

In conclusion, the lower guide assembly for an elevator landing door system according to the utility model is simple in structure, reliable in safety, and extremely convenient in mounting and dismounting. Moreover, in the whole process of closing and opening the elevator landing door, the landing door plate can be effectively prevented from falling off from the guide slot of the sill component, so as to eliminate the potential safety hazard of passenger falling. Therefore, it is extremely recommended to promote and apply the lower guide assembly for an elevator landing door system in elevator systems.

The lower guide assembly for an elevator landing door system and the elevator system provided with the lower guide assembly for an elevator landing door system according to the utility model are illustrated in detail above by listing several specific implementation manners. These examples are merely used for illustrating the principles and implementation manners of the utility model, instead of limiting the utility model. Those of ordinary skill in the art can make various variations and improvements without departing from the spirit and scope of utility model. For example, the anti-off component can be designed in the form of a bolt. Therefore, all equivalent technical solutions should fall within the scope of the utility model and defined by claims of the utility model.

1. A lower guide assembly for an elevator landing door system, comprising:
a landing door plate;
an anti-off component detachably fixed under the landing door plate and comprising a body having a smaller width and a head having a greater width; and
a sill component comprising: a base; and a first support and a second support that are detachably mounted on the base, wherein the first support, the second support and the base form a guide slot that extends along a translating direction of the landing door plate and is used to at least partially accommodate the anti-off component, and the width of a space of the guide slot that is used to accommodate the body of the anti-off component is less than the width of the head of the anti-off component to prevent the anti-off component from falling off from the guide slot,
characterised in that the base is provided with a first protrusion that extends toward the first support at an outer side near the first support, and the first support is provided with a recess used to accommodate the first protrusion.

2. The lower guide assembly for an elevator landing door system according to claim 1, characterised in that the base is provided with a second protrusion that extends toward the second support at an outer side near the second support, and the second support is provided with a recess used to receive the second protrusion.

3. The lower guide assembly for an elevator landing door system according to claim 2, characterised in that the base comprises a bottom wall, and a first sidewall and a second sidewall that are located at two sides of the bottom wall, the first protrusion extends toward the first support from an end portion of the first sidewall, and the second protrusion extends toward the second support from an end portion of the second sidewall.

4. The lower guide assembly for an elevator landing door system according to claim 3, characterised in that the first protrusion and the second protrusion extend along a direction parallel to the bottom wall of the base.

5. The lower guide assembly for an elevator landing door system according to claim 2, characterised in that the first support and/or the second support are/is fixed on the base by a fastener.

6. The lower guide assembly for an elevator landing door system according to claim 2, characterised in that the guide slot has an L-shaped or an inverted T-shaped cross section.

7. The lower guide assembly for an elevator landing door system according to claim 2, characterised in that the first support and the second support are in the same shape and are arranged on two sides of the base symmetrically.

8. The lower guide assembly for an elevator landing door system according to claim 2, characterised in that the bottom of the landing door plate is provided with multiple anti-off components that are spaced from each other.

9. The lower guide assembly for an elevator landing door system according to claim 2, characterised in that the anti-off component is fixed under the landing door plate by a fastener.

10. The lower guide assembly for an elevator landing door system according to claim 9, characterised in that the anti-off component is a metal component having an L-shaped or an inverted T-shaped cross section.

11. The lower guide assembly for an elevator landing door system according to claim 3, characterised in that the first sidewall and the second sidewall are perpendicular to the bottom wall and are parallel to each other.

12. The lower guide assembly for an elevator landing door system according to claim 2, characterised in that the guide slot is provided with a boss that extends toward the body of the anti-off component.

13. The lower guide assembly for an elevator landing door system according to claim 8, characterised in that at least one of the multiple anti-off components is arranged at an end portion near the landing door plate.

14. The lower guide assembly for an elevator landing door system according to claim 2, characterised in that the first support and the second support are made of aluminum alloy.

15. The lower guide assembly for an elevator landing door system according to claim 2, characterised in that the base and/or the anti-off component are/is made of steel.

16. The lower guide assembly for an elevator landing door system according to claim 1, characterised in that the anti-off component is a bolt.

17. The lower guide assembly for an elevator landing door system according to claim 1, characterised in that the lower guide assembly for an elevator landing door system further comprises a sliding block used to guide the landing door plate to move, and the guide slot is provided with a guide surface used to enable the sliding block to slide.

18. The lower guide assembly for an elevator landing door system according to claim 17, characterised in that the sliding block is fitted on the body of the anti-off component or is arranged at the bottom of the landing door plate and spaced from the anti-off component.

19. The lower guide assembly for an elevator landing door system according to claim 18, characterised in that the sliding block is made of an abrasion-proof material.

20. An elevator system, characterised in that the elevator system is provided with the lower guide assembly for an elevator landing door system according to claim 1.
